(19) United States
(12) Patent Application Publication
(10) Pub. No.: US 2021/0105928 A1
(43) Pub. Date: Apr. 15, 2021

(54) SYSTEM AND METHOD FOR MANAGING MATERIAL ACCUMULATION RELATIVE TO GROUND ENGAGING TOOLS OF AN AGRICULTURAL IMPLEMENT

(71) Applicant: CNH Industrial Canada, Ltd., Saskatoon (CA)

(72) Inventor: James W. Henry, Saskatoon (CA)

(73) Assignee: CNH Industrial Canada, Ltd.

(21) Appl. No.: 16/600,934

(22) Filed: Oct. 14, 2019

(51) Int. Cl. A01B 63/111; A01B 23/02; A01B 63/24; E02F 9/26

(52) U.S. Cl. CPC A01B 63/1112; E02F 9/267; A01B 63/245; A01B 23/02

(57) ABSTRACT

A system for managing material accumulation relative to agricultural implements may include a ground engaging tool supported on an agricultural implement and a field surface characteristic sensor. The field surface characteristic sensor may be configured generate data indicative of a field surface characteristic of an aft portion of the field located rearward of the ground engaging tool relative to a direction of travel of the agricultural implement. The system may further include a controller communicatively coupled to the field surface characteristic sensor. The controller may be configured to monitor the data received from the field surface characteristic sensor and determine a presence of material accumulation relative to the ground engaging tool based at least in part on the field surface characteristic of the aft portion of the field.

### FIELD OF THE INVENTION

The present subject matter relates generally to agricultural implements, and more particularly, to a system and an associated method for managing material accumulation relative to ground engaging tools of an agricultural implement during the performance of an agricultural operation.

### BACKGROUND OF THE INVENTION

A wide range of agricultural implements have been developed and are presently in use for tilling, cultivating, harvesting, and so forth. Tillage implements, for example, are commonly towed behind tractors and may cover wide swaths of ground that include various types of residue. Such residue may include materials left in the field after the crop has been harvested (e.g., stalks and stubble, leaves, and seed pods). Good management of field residue can increase efficiency of irrigation and control of erosion in the field.

Tillers typically include ground-engaging tools, such as shanks and shank attachment members (e.g., tillage points, chisels, etc.), configured to condition the soil to reduce soil compaction from sources such as machine traffic, grazing cattle, and standing water, while improving moisture distribution by managing the residue within the field. During a tillage operation within the field, residue flows around the shanks and shank attachment members to form a uniform residue layer across the soil within the field. However, when field materials, such as residue, soil, and/or the like, begin to accumulate on the shanks, the distribution of the residue may be affected, which can affect irrigation and erosion within the field. As a result, an operator of the implement must closely monitor the performance of the implement for indications of material accumulation, which may distract the operator from other duties.

Accordingly, a system and method for managing material accumulation relative to ground engaging tools of an agricultural implement would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to a system for managing material accumulation relative to agricultural implements. The system includes a ground engaging tool supported on an agricultural implement. The system further includes a field surface characteristic sensor configured generate data indicative of a field surface characteristic of an aft portion of the field located rearward of the ground engaging tool relative to a direction of travel of the agricultural implement. Additionally, the system includes a controller communicatively coupled to the field surface characteristic sensor. The controller is configured to monitor the data received from the field surface characteristic sensor and determine a presence of material accumulation relative to the ground engaging tool based at least in part on the field surface characteristic of the aft portion of the field.

In another aspect, the present subject matter is directed to a method for managing material accumulation relative to agricultural implements. The method includes receiving, with a computing device, data indicative of a field characteristic of an aft portion of a field located rearward of a ground engaging tool of an agricultural implement relative to a direction of travel of the agricultural implement. Further, the method includes analyzing, with the computing device, the field characteristic of the aft portion of the field to determine whether material accumulation is present relative to the ground engaging tool of the agricultural implement. Additionally, the method includes, when the presence of material accumulation is determined, initiating, with the computing device, a control action associated with reducing an amount of material accumulation relative to the ground engaging tool.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a side view of one embodiment of an agricultural implement in accordance with aspects of the present subject matter;

FIG. 2 illustrates a perspective view of the agricultural implement shown in FIG. 1 in accordance with aspects of the present subject matter, particularly illustrating an aft portion of the field rearward of the agricultural implement:

FIG. 3 illustrates a side view of a shank assembly of the agricultural implement shown in FIGS. 1 and 2 in accordance with aspects of the present subject matter, particularly illustrating a normal operating condition of the shank assembly:

FIG. 4 illustrates a section view of the aft portion of the field shown in FIG. 2 in accordance with aspects of the present subject matter, particularly illustrating surface features of the field surface created during a normal operating condition of shank assemblies of the implement;

FIG. 5 illustrates another side view of the shank assembly shown in FIG. 3 in accordance with aspects of the present subject matter, particularly illustrating a plugged operating condition of the shank assembly;

FIG. 6 illustrates an example section view of the aft portion of the field shown in FIG. 2 in accordance with aspects of the present subject matter, particularly illustrating surface features of the field surface created during a plugged operating condition of two of the shank assemblies of the implement:

FIG. 7 illustrates a schematic view of one embodiment of a system for managing material accumulation relative to ground engaging tools of the agricultural implement shown in FIG. 1 in accordance with aspects of the present subject matter; and

FIG. 8 illustrates a flow diagram of one embodiment of a method for managing material accumulation relative to ground engaging tools of an agricultural implement shown in accordance with aspects of the present subject matter.

Repeat use of reference characters in the present specification and drawings is intended to represent the same or analogous features or elements of the present technology.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to a system and method for managing material accumulation relative to ground engaging tools of an agricultural implement. Specifically, in several embodiments, the disclosed system may monitor field surface characteristics of the field behind the implement as the implement performs an operation within the field to determine when material accumulation, particularly residue, has built up on the ground engaging tools of the implement. For instance, in accordance with aspects of the present subject matter, a field surface characteristic sensor may be provided in association with the implement, with the field surface characteristic sensor being configured to capture data indicative of at least one of a contour or a residue coverage of the field rearward of the implement. As residue accumulates on the ground engaging tools, the contour and/or the residue coverage of the aft portion of the field located rearward of the ground engaging tools changes. Particularly, the contour and the residue coverage of the field changes at areas associated with ground engaging tools that are experiencing material accumulation. Accordingly, a controller of the disclosed system may be configured to determine material accumulation relative to ground engaging tools of the implement based on one or both of the detected contour and the detected residue coverage of the field. In some embodiments, the controller may further be configured to automatically initiate a control action to manage the material accumulation relative to the ground engaging tools. For instance, in one embodiment, the control action may include adjusting the operation of one or more actuators of the implement to adjust the penetration depth of at least the ground engaging tools experiencing material accumulation.

For example, in some embodiments, the ground engaging tools are shank assemblies, where each shank assembly creates a V-shaped surface feature within the field. As more residue accumulates on the shank assemblies, the contour and the residue coverage of the associated surface features changes. For instance, the surface features may become wider or deeper than during normal operating conditions. Similarly, the surface features may have gaps in the residue distribution or a lower percentage of residue coverage compared to the residue distribution during normal operating conditions. Accordingly, a controller of the disclosed system may be configured to determine material accumulation relative to shank assemblies of the implement based on one or both of the detected contour and the detected residue coverage of the field, particularly at the surface features.

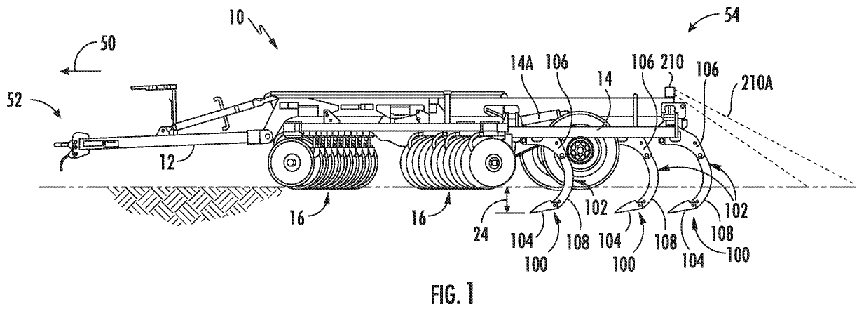

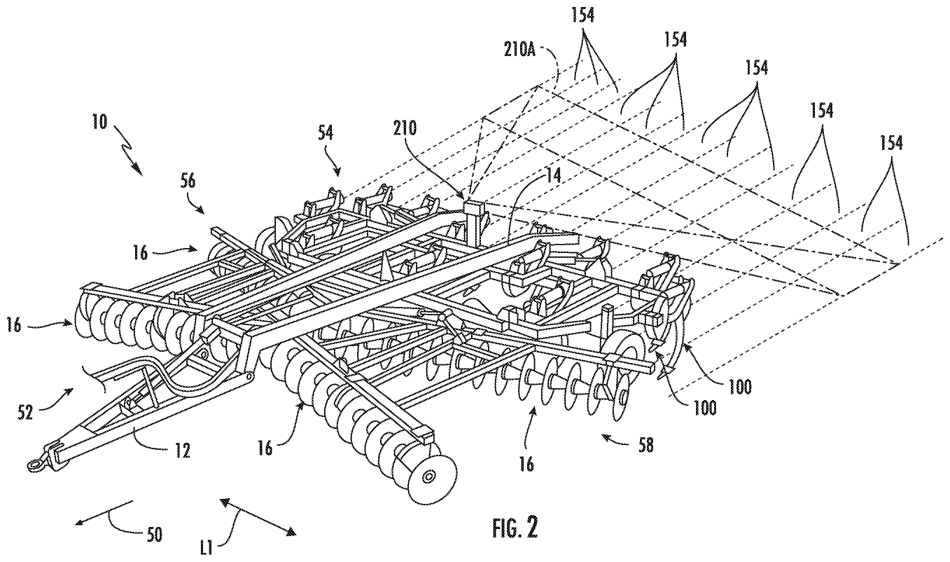

Referring now to the drawings, FIGS. 1 and 2 illustrate differing views of one embodiment of an agricultural implement 10 in accordance with aspects of the present subject matter. Specifically, FIG. 1 illustrates a side view of the agricultural implement 10. Additionally, FIG. 2 illustrates a perspective view of the implement 10, particularly illustrating an aft portion of the field rearward of the implement 10.

As shown, the implement 10 is configured as a tillage implement. However, in other embodiments, the implement 10 may have any other suitable implement configuration, such as by being configured as any other suitable multi-wing implement, including any other suitable tillage implement (e.g., a cultivator) or other implement (e.g., a planter, seeder, sprayer, fertilizer, and/or the like).

As is generally understood, the implement 10 may be used to till a field to prepare the soil by plowing, ripping, turning, and/or the like. In doing so, a portion of the soil residue, such as plant stalks and/or weeds, may be removed during the tilling process. In addition, the soil may be loosened and aerated, which in turn facilitates deeper penetration of roots. The tilling process may also help in the growth of microorganisms present in the soil and thus, maintain the fertility of the soil.

As shown in FIGS. 1 and 2, the implement 10 includes a tow bar 12 having a coupling mechanism, such as a hitch, used to couple the implement 10 to a towing vehicle, such as a tractor. The implement 10 may also include a frame 14 extending longitudinally between a forward end 52 and an aft end 54 of the implement 10, generally parallel to the direction of travel 50. As shown in FIG. 2, the implement 10 also extends along a lateral direction L1 defined between a first lateral side 56 and a second lateral side 58 of the implement 10. The implement 10 may further include a plurality of ground-engaging tools coupled to or otherwise supported by the frame 14, such as one or more disk blades, plows, chisels, hoe openers, tillage points, rolling baskets, and/or the like. For instance, as shown in FIGS. 1 and 2, the tillage implement 10 includes a plurality of forward disc blades 16, and a plurality of shank assemblies 100, with the shank assemblies 100 being located aft of the forward disc blades 16 on the frame 14. The frame 14 is configured to be actuated relative to the ground between a raised position and a lowered or working position by one or more frame actuators 14A.

As shown in FIG. 1, in one embodiment, each shank assembly 100 may include both a shank 102 pivotally coupled to the implement frame 14 at one end and a shank attachment member 104 coupled to the shank 102 at its opposed end. In the embodiment shown, each shank attachment member 104 corresponds to a tillage point. As is generally understood, the tillage points 104 may be configured to enable high-speed operation of the tillage implement 10 while still producing a smooth soil surface. As shown in the illustrated embodiment, the shank assemblies 100 are positioned to till a field at a depth 24 below the field or ground surface, with the depth 24 of the tillage points 104 being adjustable by raising or lowering the shank assemblies 100 and/or the portions of the frame 14 relative to the field. For example, the depth 24 may be adjusted, as desired, based on local farming practices and/or field conditions. It should be appreciated that, in other embodiments, each shank attachment member 104 may correspond to any other ground-engaging member beyond a tillage point that is configured to be coupled or attached to the distal end of a shank 102, e.g., chisels, hoe openers, and/or the like.

In accordance with aspects of the present subject matter, the implement 10 may be configured to support one or more sensors that generate or provide data indicative of the presence of material accumulation relative to one or more of the ground engaging tools of the implement 10. For instance, one or more sensors may be mounted to or supported on the implement 10 for monitoring material accumulation relative to one or more of the ground engaging tools, such as the shank assemblies 100, of the implement 10. For example, as shown in FIGS. 1 and 2, a field surface characteristic sensor 210 is mounted to or supported on the implement 10, with the field surface characteristic sensor 210 having a field of view 210A directed towards the field.

More particularly, the field surface characteristic sensor 210 may be supported relative to the implement 10 (e.g., adjacent to the aft end 54 of the implement 10) such that the field of view 210A of the field surface characteristic sensor 210 is directed towards an aft portion of the field disposed rearward of the implement 10 relative to the direction of travel 50 of the implement 10. As such, the field surface characteristic sensor 210 may be configured to generate data indicative of one or more field surface characteristics associated with the aft portion of the field located behind or aft of the implement 10. For instance, in one embodiment, the field surface characteristic sensor 210 may be configured to generate data indicative of a contour or profile of the aft portion of the field. In some embodiments, the field surface characteristic sensor 210 may also be configured to generate data indicative of the residue coverage associated with the aft portion of the field. In this regard, the field surface characteristic sensor 210 may be configured as any suitable device, such as camera(s) (including stereo camera(s), and/or the like), LIDAR device(s), radar sensor(s), ultrasonic sensor(s), and/or the like, that allows the field surface characteristic sensor 210 to generate image data, point-cloud data, radar data, ultrasound data, and/or the like indicative of the contour and/or the residue coverage of the aft portion of the field.

Particularly, as shown in FIG. 2, the aft portion of the field located rearward of the implement 10 may be divided along the lateral direction L1 into lateral portions or “lanes” 154. Each lane 154 is associated with a respective one of the shank assemblies 100. Specifically, each lane 154 is aligned along the direction of travel 50 with and worked by the respective shank assembly 100. The field surface characteristics of the aft portion of the field, particularly at least one of the surface contour or the residue coverage, within each of the lanes 154 detected by the field surface characteristic sensor(s) 210 will generally be consistent during normal operation of the implement 10, e.g., when the shank assemblies 100 do not have material accumulated relative thereto or are otherwise not in a “plugged operating condition”, and, thus, represent baseline surface characteristics to be expected during normal operation. As such, deviation from such baseline surface characteristics may be indicative of a plugged operating condition of one or more of the shank assemblies 100, as will be described in greater detail below.

It should be appreciated that, while the implement is shown as only including or being associated with one field surface characteristic sensor 210, the implement 10 may include or be associated with any other suitable number of field surface characteristic sensors 210, such as two or more field surface characteristic sensors 210. Further, in alternative embodiments, the field surface characteristic sensor 210 may be supported at any other suitable location on the implement 10 and/or a vehicle towing the implement 10 such that the field of view 210A of the field surface characteristic sensor 210 is directed towards the aft portion of the field and/or any other suitable portion of the field.

Additionally, it should also be appreciated that the configuration of the implement 10 described above and shown in FIG. 1 is provided only to place the present subject matter in an exemplary field of use. Thus, it should be appreciated that the present subject matter may be readily adaptable to any manner of implement configuration or ground engaging tool, e.g., disc blades, plows, chisels, or hoe openers.

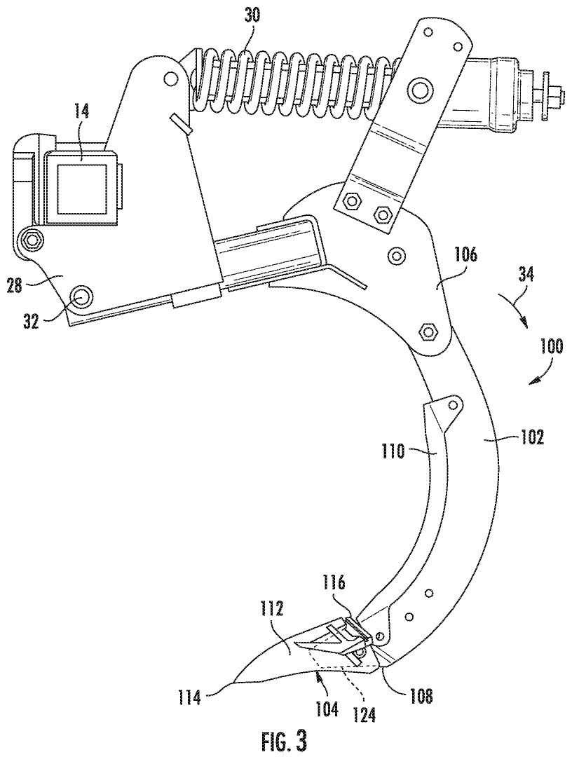

Referring now to FIG. 3, a side view of an example embodiment of a shank assembly 100 suitable for use with an agricultural implement (e.g., the implement 10 shown in FIGS. 1 and 2) is illustrated in accordance with aspects of the present subject matter. It should be appreciated that, for purposes of discussion, the shank assembly 100 will be described with reference to the tillage implement 10 shown in FIG. 1. However, those of ordinary skill in the art will readily appreciate that the disclosed shank assemblies 100 may be utilized with any suitable agricultural implements having any other suitable implement configuration(s).

In general, as shown in FIG. 3, the shank assembly 100 may include a shank 102 configured to be pivotally coupled to the implement frame 14 and a tillage point 104 configured to be coupled to the shank 102. For instance, the shank 102 may extend lengthwise between a proximal end 106 and a distal end 108, with the proximal end 106 being configured to be coupled to the implement frame 14, e.g., via a mount 28 rigidly coupled to the implement frame 14, and the distal end 108 being configured to be coupled to the tillage point 104. For example, the tillage point 104 may generally include a body 112 extending lengthwise between a tip end 114 and an opposed retention end 116, where the retention end 116 of the body 112 may generally be configured to allow the distal end 108 of the shank 102 to be coupled to the tillage point 102. For instance, in one embodiment, the retention end 116 of the body 112 may include a retention slot 124 defined therein for receiving the distal end 108 of the shank 102.

In some embodiments, the shank 102 is C-shaped, as shown. However, in other embodiments the shank 102 may have any other suitable shape. As shown in FIG. 3, the shank assembly 100 may also include a biasing member 30 (e.g., a spring) coupled between the shank 102 and the mount 28 to bias the shank 102 towards its ground-engaging position relative to the frame (e.g., the position shown in FIG. 3). For instance, the biasing member 30 may bias the shank 102 downwardly such that the shank pivots about a pivot point 32 defined between the shank 102 and the mount 28 back towards its ground-engaging position (e.g., in pivot direction indicated by arrow 34) following temporary pivotal movement of the shank 102 in the opposite direction as the shank 102 encounters rocks or other impediments in the field during operation of the implement 10. Additionally, in some embodiments, the shank assembly 100 may include a shin 110 configured to be coupled to the shank 102 above the tillage point 104 to protect the shank 102 from wear.

During a normal, non-plugged operating condition of the shank assembly 100, the shank 102 is generally free of accumulated residue, soil, and/or other field debris such that known or expected field surface characteristics of the aft portion of the field located immediately behind the shank 102 are present or formed within the field as the shank 102 functions to work such portion of the field.

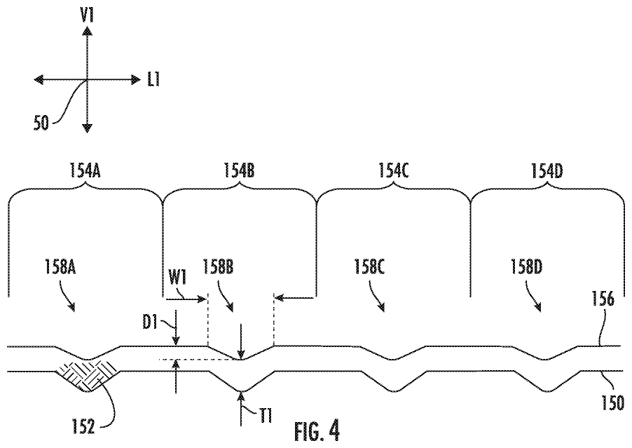

For instance, referring now to FIG. 4, a section view of the aft portion of the field rearward of the implement 10 is illustrated, particularly illustrating surface features of the field surface created during a normal operating condition of shank assemblies of the implement. It should be appreciated that, for purposes of discussion, the section view of the aft portion of the field will be described with reference to the tillage implement 10 shown in FIG. 1 and the shank assembly 100 shown in FIG. 2 having the shank 102 and tillage point 104. However, those of ordinary skill in the art will readily appreciate that the disclosed section view of the aft portion of the field may be formed utilizing any suitable agricultural implements having any other suitable implement configuration(s), sensor(s), or ground engaging tools.

Particularly, the section of the aft portion of the field extends in a plane extending along the lateral direction L1 and a vertical direction V1, with the vertical direction V1 extending perpendicular to both the direction of travel 50 and the lateral direction L1 of the implement 10. The field may generally be divided along the vertical direction V1 into a soil layer 150 and a residue layer 152 above the soil layer 150, with the soil layer 150 being comprised mainly of soil and the residue layer 152 being comprised mainly of crop residue. In one embodiment, such as that shown in FIG. 4, the residue layer 152 is continuous and has a substantially consistent thickness T1 across the width of the field, such that a baseline field surface 156 of the aft portion of the field created during a normal operating condition of shank assemblies generally corresponds to a surface of the residue layer 152.

As indicated above, the aft portion of the field may further be divided along the lateral direction L1 into the lanes 154, with each lane 154 corresponding to a lateral portion of the field aligned with and worked by a respective one of the ground engaging tools of the implement 10. For example, a first lane 154A is aligned with a first one of the shank assemblies 100 in the direction of travel 50 of the implement, with field surface characteristics of the field within the first lane 154A generally being affected by material accumulation on the first one of the shank assemblies. A second lane 154B is aligned with a second one of the shank assemblies 100 in the direction of travel 50 of the implement 10, with field surface characteristics of the field within the second lane 154B generally being affected by material accumulation on the second one of the shank assemblies. A third lane 154C is aligned with a third one of the shank assemblies 100 in the direction of travel 50 of the implement 10, with field surface characteristics of the field within the third lane 154C generally being affected by material accumulation on the third one of the shank assemblies. Additionally, a fourth lane 154D is aligned with a fourth one of the shank assemblies 100 in the direction of travel 50 of the implement 10, with field surface characteristics of the field within the fourth lane 154D generally being affected by material accumulation on the fourth one of the shank assemblies.

As shown in FIG. 4, a lane profile or contour of each lane 154 includes a surface feature 158 created during operation of the implement 10. For example, the lane profile of the first lane 154A has a first surface feature 158A, the lane profile of the second lane 154B has a second surface feature 158B, the lane profile of the third lane 154C has a third surface feature 158C, and the lane profile of the fourth lane 154D has a fourth surface feature 158D. In general, the surface features 158 are V-shaped due to the V-shaped features that are formed in the contour of the soil layer 150 by the tillage points 104 of the shank assemblies 100. It should be appreciated that, while the surface features 158 will be discussed herein with respect to their V-shape, the surface features 158 may have any other characteristic shape depending on the type and/or shape of the tillage point 104 or other shank attachment members that may be similarly evaluated as will be described below.

During a normal, non-plugged operating condition of the implement 10, the lane profiles of the lanes 154 have an expected contour. For example, the V-shaped surface features 158 of the lane profiles of the lanes 154 may have a first or baseline width W1 and a first or baseline depth D1. In one embodiment, the baseline width W1 is measured at the opening or top of the V-shaped surface features 158 along the vertical direction V1. However, the baseline width W1 may be measured at any other depth of the surface features 158. In some embodiments, the width of the surface features 158 is greatest at the opening. Further, in one embodiment, the baseline depth D1 is measured between the opening of the surface features 158 and the lowest point of the surface features 158 along the vertical direction V1. However, in some embodiments, the baseline depth D1 may instead be measured between a normal or expected field surface and the lowest point of the surface features 158 along the vertical direction. Each of the baseline width W1 and the baseline depth D1 is indicative of a normal, non-plugged operating condition of the shank assemblies 100. Accordingly, any deviation from the baseline depth D1 and/or the baseline width W1 may be indicative of a plugged operation condition of the respective shank assembly 100, as will be described in greater detail below.

The residue coverage, including the distribution of residue and/or the percentage of residue coverage, along the surface of the aft portion of the field may also have baseline or expected values during normal, non-plugged operating condition of the shank assemblies 100. For instance, during normal operation of the shank assemblies 100, it is generally expected that an even, continuous distribution of residue will be present across the entire lateral width L1 of the field surface 156, e.g., across the lanes 154 and between the lanes 154, such that there are no “gaps” in the residue layer 152 across the field surface 156. Similarly, it is also generally expected that a substantially constant percentage of residue coverage will exist across the entire lateral width L1 of the field, e.g., across the lanes 154 and between the lanes 154, such that the thickness T1 of the residue layer 152 is substantially constant across the field surface 156. Accordingly, deviations from the expected or baseline residue coverage, such as a value corresponding to the quality of the distribution of residue and/or percentage of residue coverage, may indicate a plugged operating condition of the respective shank assembly(ies) 100, as will be described further below.

Based on the relative field surface characteristics of the field surface 156 within the different lanes 154A, 154B, 154C, 154D of the field located aft of the implement 10, material accumulation relative to the shank assemblies 100 of the implement 10 may be determined. For example, the contour of the field surface may be compared to the baseline field surface 156 to determine when a plugged operating condition is occurring. Particularly, the surface features of the contour of the field surface may be compared to the surface features 158 of the contour of the baseline field surface 156 to determine the plugged operating condition. Similarly, the residue coverage, such as the distribution of residue and/or the percentage of residue coverage, of the field surface may be compared to the residue coverage of the baseline field surface 156 to determine when a plugged operating condition is occurring. Particularly, the residue coverage of the surface features of the field surface may be compared to the residue coverage of the surface features 158 of the baseline field surface 156 to determine the plugged operating condition.

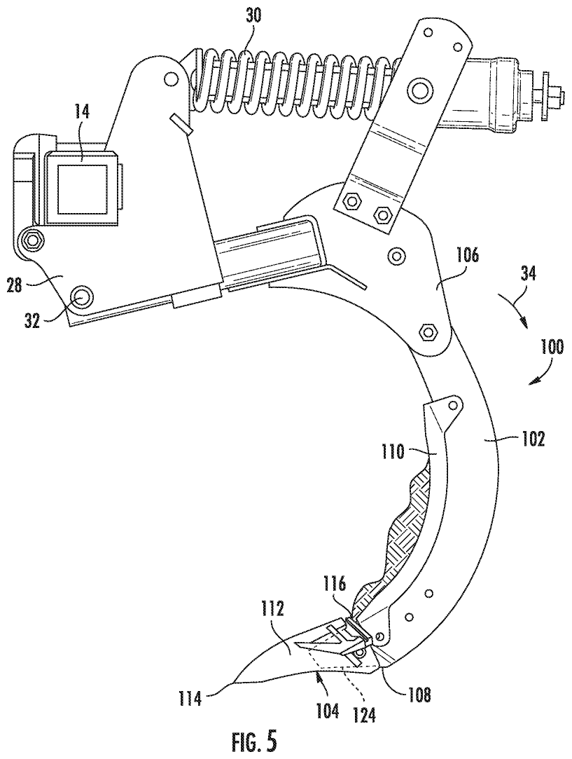

For instance, referring now to FIG. 5, another side view of the shank assembly 100 shown in FIG. 3 is illustrated in accordance with aspects of the present subject matter, particularly illustrating a plugged operating condition of the shank assembly 100. As shown in FIG. 5, during a plugged operating condition of the shank assembly 100, field materials, such as residue, soil, and/or other field debris, accumulate on the shank 102 of the shank assembly 100. During such a plugged operating condition, the field surface characteristics of the field surface aft of the shank assembly 100 will vary from the baseline field surface characteristics described above.

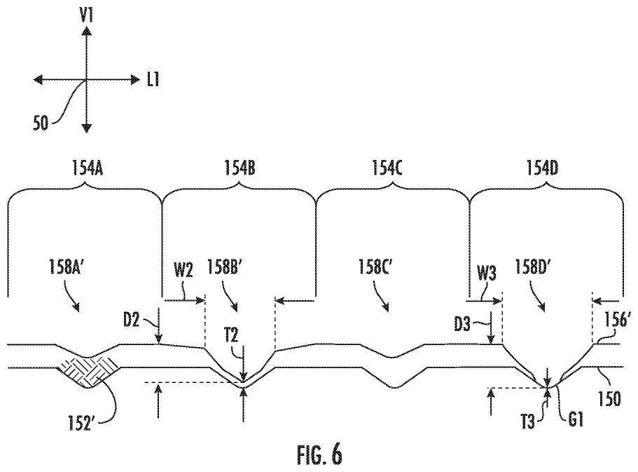

For example, FIG. 6 illustrates an example section view of the aft portion of the field rearward of the implement 10 created by such a plugged operating condition of two of the associated shank assemblies 100. As shown in FIG. 6, the field surface characteristics of the field surface 156′ are different during the plugged operating condition of the shank assemblies 100 than during the normal operating condition of the shank assemblies 100. Particularly, the residue layer 152′ created during such plugged operating condition has a varying thickness across the lateral width L1 of the field. Specifically, the thickness of the residue layer 152′ varies such that a thickness T2 of the residue layer 152′ at a second surface feature 158B′ within the second lane 154B and a thickness T3 of the residue layer 152′ at a fourth surface feature 158D′ within the fourth lane 154D created during the plugged operation are less than the thickness T1 at the surface feature 158B created during the normal operating condition.

Such variations in thickness may be represented by a banded residue distribution or a change in residue coverage percentage. For instance, the thickness T3 at the fourth surface feature 158D′ is equal to zero, such that a gap G1 is formed where no residue is present at the field surface 156′, compared to the relatively gap-less field surface 156 shown in FIG. 4, which creates a banded appearance or stripe in the field surface. Such banded appearance indicated that the shank assembly associated with the fourth lane 154d has gathered or accumulated residue. Similarly, the percentages of residue coverage within the second and fourth lanes 154B, 154D, particularly at the surface features 158B′, 158D′ within the second and fourth lanes 154B, 154D, are lower than the surrounding areas and the baseline or expected percentage of residue coverage of the baseline field surface 156. Such residue coverage values indicate that the shank assemblies 100 associated with the second and fourth lanes 154B, 154D have gathered or accumulated residue.

Further, as more residue collects on the shank(s) 102, less or no residue may collect in the V-shaped surface features formed in the contour of the soil layer 150, which changes the contours of V-shaped surface features of the lanes 154 associated with the shank(s) 102 experiencing material accumulation. For instance, the V-shaped surface feature 158B′ of the second lane 154B associated with the second one of the shank assemblies 100 has a second width W2 and a second depth D2, where the second width W2 and the second depth D2 are different than the baseline width W1 and the baseline depth D1. Similarly, the V-shaped surface feature 158D′ of the fourth lane 154D associated with the fourth one of the shank assemblies 100 has a third width W3 and a third depth D3, where the third width W3 and the third depth D3 are different than the baseline width W1 and the baseline depth D1. For instance, in one embodiment, the second and third widths W2, W3 of the surface features 158B′, 154D′ of the second and fourth lanes 154B, 154D are wider than the baseline width W1 of the surface feature 158B of the second lane 154B. Similarly, in some embodiments, the second and third depths D2, D3 of the surface features 158B′ 158D′ of the second and fourth lanes 154B′, 154D′ are deeper than the baseline depth D1 of the surface feature 158B of the second lane 154B, where the third depth D3 is deeper than the second depth D2. Thus, the change in the width and/or depth of the V-shaped surface features 158′ from the baseline width W1 and baseline depth D1 of the V-shaped surface features 158 each indicate that residue or other field materials have accumulated on the shank 102 of the shank assembly 100 associated with the second lane 154B.

Referring now to FIG. 7, a schematic view of one embodiment of a system 200 for managing material accumulation relative to ground engaging tools of an agricultural implement is illustrated in accordance with aspects of the present subject matter. As will be described below, the system 200 allows for various portions of an implement to be actuated to reduce material accumulation relative to ground engaging tools of the agricultural implement. For purposes of discussion, the system 200 will be described herein with reference to the implement 10 described above and shown in FIGS. 1 and 2, the shank assemblies 100 described above and shown in FIGS. 1-3 and 5, and the field surface contours 156, 156′ described above and shown in FIGS. 4 and 6. However, it should be appreciated that the disclosed system 200 may generally be utilized with any suitable implement having any suitable implement configuration. Additionally, it should be appreciated that communicative links or electrical couplings of the system 200 shown in FIG. 7 are indicated by dashed lines.

As shown, the system 200 includes a controller 202 configured to electronically control the operation of one or more components of the agricultural implement 10. In general, the controller 202 may comprise any suitable processor-based device known in the art, such as a computing device or any suitable combination of computing devices. Thus, in several embodiments, the controller 202 may include one or more processor(s) 204, and associated memory device(s) 206 configured to perform a variety of computer-implemented functions. As used herein, the term “processor” refers not only to integrated circuits referred to in the art as being included in a computer, but also refers to a controller, a microcontroller, a microcomputer, a programmable logic circuit (PLC), an application specific integrated circuit, and other programmable circuits. Additionally, the memory device(s) 206 of the controller 202 may generally comprise memory element(s) including, but not limited to, a computer readable medium (e.g., random access memory RAM)), a computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory device(s) 206 may generally be configured to store suitable computer-readable instructions that, when implemented by the processor(s) 204, configure the controller 202 to perform various computer-implemented functions, such as one or more aspects of the methods and algorithms that will be described herein. In addition, the controller 202 may also include various other suitable components, such as a communications circuit or module, one or more input/output channels, a data/control bus and/or the like.

It should be appreciated that, in several embodiments, the controller 202 may correspond to an existing controller of the agricultural implement 10 and/or of a work vehicle to which the implement 10 is coupled. However, it should be appreciated that, in other embodiments, the controller 202 may instead correspond to a separate processing device. For instance, in one embodiment, the controller 202 may form all or part of a separate plug-in module that may be installed within the agricultural implement 10 to allow for the disclosed system and method to be implemented without requiring additional software to be uploaded onto existing control devices of the agricultural implement 10.

In some embodiments, the controller 202 may include a communications module or interface 208 to allow for the controller 202 to communicate with any of the various other system components described herein. For instance, as described above, the controller 202 may, in several embodiments, be configured to receive data inputs from one or more sensors of the agricultural implement 10 that are used to detect one or more parameters associated with the status of material accumulation relative to the ground engaging tools of the implement 10. Particularly, the controller 202 may be in communication with one or more field surface characteristic sensors configured to detect one or more parameters associated with or indicative of material accumulation relative to ground engaging tools of the implement 10. In one embodiment, the controller 202 may be communicatively coupled to the field surface characteristic sensor(s) 210 via any suitable connection, such as a wired or wireless connection, to allow data indicative of material accumulation relative to ground engaging tools of the implement 10 to be transmitted from the sensor(s) 210 to the controller 202.

Specifically, referring back to FIGS. 1-6, the field surface characteristic sensor(s) 210 may be installed or otherwise positioned relative to the implement 10 to capture data (e.g., image data, point-cloud data, radar data, ultrasound data, and/or the like) indicative of the field surface characteristics of an aft portion of the field, each of which, in turn, is indicative of material accumulation relative to ground engaging tools, e.g., shank assemblies 100, of the implement 10. Thus, in several embodiments, the controller 202 may be configured to monitor material accumulation relative to the ground engaging tools of the implement 10 based on the data received from the sensor(s) 210. For example, the controller 202 may be configured to analyze/process the received data to monitor the field surface characteristics detected within the aft portion of the field relative to a baseline or expected field surface characteristics, respectively. For instance, the controller 202 may include one or more suitable algorithms stored within its memory 206 that, when executed by the processor 204, allow the controller 202 to infer the presence of material accumulation relative to ground engaging tools of the implement 10 based on the data received from the sensor(s) 210.

In several embodiments, the controller 202 may be configured to determine that one or more of the shank assemblies 100 is experiencing a plugged operating condition based on the detected contour of the field surface of the aft portion of the field located rearward of the implement 10. In general, the contour of the field surface 156, 156′ is made up of lane profiles within lanes 154, where each lane is associated with a respective shank assembly 100 and has a surface feature 158, 158′. When the shank assemblies 100 are experiencing an unplugged or normal operating condition, the surface features 158 of the field surface 156 have a baseline or expected width W1 and a baseline or expected depth D1 as shown in FIG. 4. When one or more of the shank assemblies 100 are experiencing a plugged operating condition, the contour of the field surface 156′ is different from the contour of the field surface 156 formed during the unplugged operating condition. Particularly, the surface features 158′ of the lane profiles within the lanes 154 may have an increased width and/or depth, such as the second width W2 and second depth D2 shown in FIG. 6. As such, in one embodiment, the controller 202 may be configured to compare the width and/or depth of the contours of the surface features 158′ detected by the field surface characteristic sensor(s) 210 to the width W1 and/or depth D1 of the contours of the baseline surface features 158 to assess the plugging condition of the associated shank assemblies 100. For instance, when the width and/or depth of the surface features of the field surface detected by the field surface characteristic sensor(s) 210 is not approximately equal to the respective baseline width W1 or the baseline depth D1 of the surface features 158 (e.g., not within a first tolerance of each other), the controller 202 may determine that the associated ones of the shank assemblies 100 are experiencing a plugged operating condition.

In some embodiments, the controller 202 may be configured to determine that one or more of the shank assemblies 100 is experiencing a plugged operating condition based on the residue coverage of the field surface of the aft portion of the field located rearward of the implement 10. In general, when the shank assemblies 100 are experiencing an unplugged or normal operating condition, the residue across the field surface 156, particularly across each of the lane profiles within lanes 154 associated with the unplugged shank assemblies 100 and the surface features 158 of each lane profile, is distributed such that there are no “gaps” in the residue across the entire lateral width L1 of the field surface 156. Similarly, the percentage of residue coverage across the field surface 156, particularly across each of the lane profiles within lanes 154 associated with the unplugged shank assemblies 100 and the surface features 158 of each lane profile, is generally constant or uniform across the entire lateral width L1 of the field surface 156. When one or more of the shank assemblies 100 are experiencing a plugged operating condition, the residue coverage value of the field surface is different from the expected residue coverage value of the field surface formed during the unplugged operating condition. As such, in one embodiment, the controller 202 may be configured to compare the residue distribution and/or percentage of residue coverage of the field surface detected by the field surface characteristic sensor(s) 210 to the residue distribution and/or percentage of residue coverage of the baseline field surface 156 to assess the plugging condition of the associated shank assemblies 100. For instance, when the residue distribution and/or percentage of residue coverage of the surface features of the field surface detected by the field surface characteristic sensor(s) 210 is not approximately equal to the respective residue distribution and/or percentage of residue coverage of the surface features 158 of the baseline field surface 156 (e.g., not within a first tolerance of each other), the controller 202 may determine that the associated ones of the shank assemblies 100 are experiencing a plugged operating condition.

Additionally, in several embodiments, the controller 202 may be configured to perform one or more implement-related control actions based on the data received from the sensor(s) 210. Specifically, the controller 202 may be configured to control one or more components of the agricultural implement 10 based on the determination of material accumulation relative to one or more of the ground engaging tools of the implement 10 to manage, e.g., reduce, the material accumulation. For example, as shown in FIG. 7, the controller 202 may be configured to control one or more implement actuators, such as the frame actuator(s) 14A, to change (e.g., increase or decrease) the penetration depth 24 of the shank assemblies 100.

Further, in some embodiments, the controller 202 may be configured to indicate to an operator the presence of material accumulation relative to one or more of the ground engaging tools of the implement 10. For example, in the embodiment shown in FIG. 7, the communications module 208 may allow the controller 202 to communicate with a user interface 212 having a display device configured to display information regarding the status of material accumulation relative to the ground engaging tools of the implement 10 and/or suggested control actions. However, it should be appreciated that the controller 202 may instead be communicatively coupled to any number of other indicators, such as lights, alarms, and/or the like to provide an indicator to the operator regarding the status of material accumulation relative to the ground engaging tools of the implement 10.

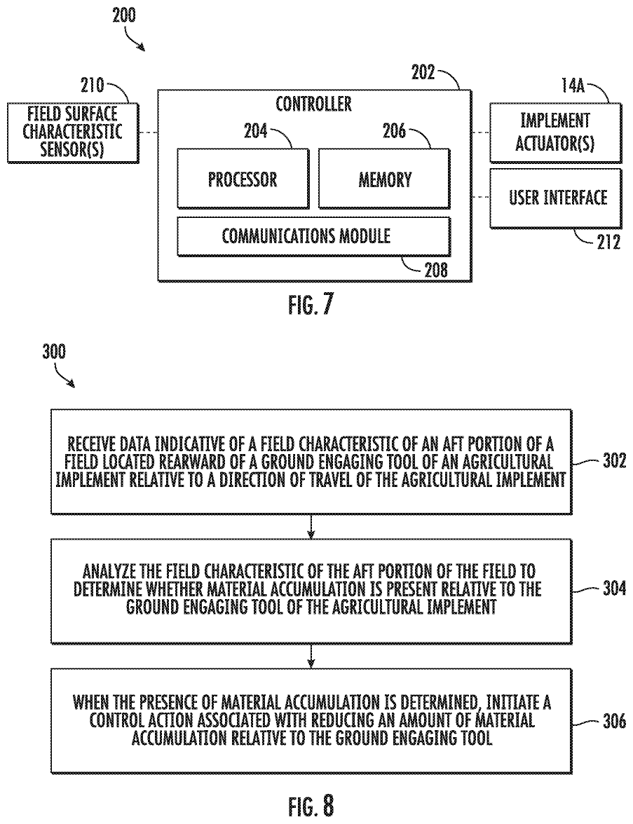

Referring now to FIG. 8, a flow diagram of one embodiment of a method 300 for managing material accumulation relative to ground engaging tools of an agricultural implement is illustrated in accordance with aspects of the present subject matter. In general, the method 300 will be described herein with reference to the implement 10 shown in FIGS. 1 and 2, the shank assemblies 100 shown in FIGS. 1-3 and 5, the field contours shown in FIGS. 4 and 6, as well as the system 200 shown in FIG. 7. However, it should be appreciated that the disclosed method 300 may be executed with implements having any other suitable configurations and/or with systems having any other suitable system configuration. In addition, although FIG. 8 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined and/or adapted in various ways without deviating from the scope of the present disclosure.

As shown in FIG. 8, at (302), the method 300 may include receiving data indicative of a field characteristic of an aft portion of a field located rearward of a ground engaging tool of an agricultural implement relative to a direction of travel of the agricultural implement. For instance, as indicated above, the controller 202 may receive an input indicative of at least one of a contour or a residue coverage of the aft portion of the field rearward of a shank assembly 100 of an agricultural implement 10 relative to a direction of travel 50 of the implement 10, such as by receiving an input from an associated field surface characteristic sensor(s) 210.

Moreover, at (304), the method 300 may include analyzing the field characteristic of the aft portion of the field to determine whether material accumulation is present relative to the at least one ground engaging tool of the agricultural implement. For instance, as described above, the controller 202 may compare the field surface characteristic detected by the field surface characteristic sensor(s) 210 at the aft portion of the field to a baseline or expected field surface characteristic. For example, in one embodiment, the controller 202 may compare a contour of the aft portion of the field (e.g., a width and/or depth of a surface feature of the aft portion of the field) detected by the field surface characteristic sensor(s) 210 to a baseline contour of the aft portion of the field to determine a presence of material accumulation. In some embodiments, the controller 202 may compare a residue coverage value (e.g., a residue distribution and/or a percentage of residue) of the aft portion of the field detected by the field surface characteristic sensor(s) 210 to a baseline or expected residue coverage value to determine a presence of material accumulation.

Additionally, at (306), the method 300 may include when the presence of material accumulation is determined, initiating a control action associated with reducing an amount of material accumulation relative to the at least one ground engaging tool. For instance, as indicated above, in some embodiments, the controller 202 may be configured to control the operation of an actuator 14A of the implement 10 to adjust the penetration depth 24 of the shank assemblies 100. In some embodiments, the controller 202 may indicate to an operator of material accumulation relative to one or more of the shank assemblies 100, e.g., by controlling the operation of the user interface 212 to display information relating to the operating condition of the shank assembly(ies) 100.

It is to be understood that the steps of the method 300 are performed by the controller 202 upon loading and executing software code or instructions which are tangibly stored on a tangible computer readable medium, such as on a magnetic medium, e.g., a computer hard drive, an optical medium, e.g., an optical disc solid-state memory, e.g., flash memory, or other storage media known in the art. Thus, any of the functionality performed by the controller 202 described herein, such as the method 300, is implemented in software code or instructions which are tangibly stored on a tangible computer readable medium. The controller 202 loads the software code or instructions via a direct interface with the computer readable medium or via a wired and/or wireless network. Upon loading and executing such software code or instructions by the controller 202, the controller 202 may perform any of the functionality of the controller 202 described herein, including any steps of the method 300 described herein.

The term “software code” or “code” used herein refers to any instructions or set of instructions that influence the operation of a computer or controller. The) may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A system for managing material accumulation relative to agricultural implements, the system comprising:
a ground engaging tool supported on an agricultural implement;
a field surface characteristic sensor configured generate data indicative of a field surface characteristic of an aft portion of the field located rearward of the ground engaging tool relative to a direction of travel of the agricultural implement; and
a controller communicatively coupled to the field surface characteristic sensor, the controller being configured to monitor the data received from the field surface characteristic sensor and determine a presence of material accumulation relative to the ground engaging tool based at least in part on the field surface characteristic of the aft portion of the field.

2. The system of claim 1, wherein the field surface characteristic comprises a contour of the aft portion of the field, wherein the controller is configured to determine the presence of material accumulation relative to the ground engaging tool by comparing the contour of the aft portion of the field to a baseline contour.

3. The system of claim 2, wherein the contour of the aft portion of the field comprises a lane profile associated with a lane of the field worked by the ground engaging tool,
wherein the baseline contour comprises an expected lane profile associated with the ground engaging tool, and
wherein the controller is configured to determine the presence of material accumulation relative to the ground engaging tool by comparing the lane profile detected within the field to the expected lane profile associated with the ground engaging tool.

4. The system of claim 3, wherein the controller is configured to determine the presence of material accumulation relative to the ground engaging tool when a width of a surface feature associated with the lane profile detected within the field is wider than a width of a corresponding surface feature associated with the expected lane profile.

5. The system of claim 4, wherein the width of the surface feature of the lane profile is measured at the top of the surface feature.

6. The system of claim 3, wherein the controller is configured to determine the presence of material accumulation relative to the ground engaging tool when a depth of a surface feature associated with the lane profile detected within the field is greater than a depth of a corresponding surface feature associated with the expected lane profile.

7. The system of claim 3, wherein the lane of the field worked by the ground engaging tool is aligned with the ground engaging tool along the direction of travel of the agricultural implement.

8. The system of claim 1, wherein the field surface characteristic comprises a residue coverage parameter of the aft portion of the field, wherein the controller is configured to determine the presence of material accumulation relative to the ground engaging tool by comparing the residue coverage parameter of the aft portion of the field to a baseline residue coverage parameter.

9. The system of claim 8, wherein the residue coverage parameter of the aft portion of the field is associated with a residue coverage value along a lane of the field worked by the ground engaging tool,
wherein the baseline residue coverage parameter comprises an expected residue coverage value for the lane of the field associated with the ground engaging tool, and
wherein the controller is configured to determine the presence of material accumulation relative to the ground engaging tool by comparing the residue coverage value detected along the lane to the expected residue coverage value of the lane associated with the ground engaging tool.

10. The system of claim 9, wherein the controller is configured to determine the presence of material accumulation relative to the ground engaging tool when the residue coverage value detected for the lane is less than the expected residue coverage value.

11. The system of claim 9, wherein the expected residue coverage value comprises at least one of a percentage of residue coverage or a distribution of residue along the lane worked by the ground engaging tool.

12. The system of claim 1, wherein the controller is further configured to initiate a control action based at least in part on the determination of the presence of material accumulation relative to the ground engaging tool.

13. The system of claim 1, wherein the field surface characteristic sensor comprises at least one of a camera, a LIDAR device, or a RADAR device.

14. A method for managing material accumulation relative to agricultural implements, the method comprising:
receiving, with a computing device, data indicative of a field characteristic of an aft portion of a field located rearward of a ground engaging tool of an agricultural implement relative to a direction of travel of the agricultural implement;
analyzing, with the computing device, the field characteristic of the aft portion of the field to determine whether material accumulation is present relative to the ground engaging tool of the agricultural implement; and
when the presence of material accumulation is determined, initiating, with the computing device, a control action associated with reducing an amount of material accumulation relative to the ground engaging tool.

15. The method of claim 14, wherein analyzing the field characteristic of the aft portion of the field comprises comparing, with the computing device, a contour of the aft portion of the field to a baseline contour.

16. The method of claim 15, wherein the contour of the aft portion of the field comprises a lane profile associated with a lane of the field worked by the ground engaging tool and the baseline contour comprises an expected lane profile associated with the ground engaging tool, wherein comparing the contour of the aft portion of the field to the baseline contour comprises comparing the lane profile detected within the field to the expected lane profile associated with the ground engaging tool.

17. The method of claim 16, wherein the presence of material accumulation relative to the ground engaging tool is determined when at least one of a width of a surface feature associated with the lane profile detected within the field is wider than a width of a corresponding surface feature associated with the expected lane profile or a depth of the surface feature associated with the lane profile detected within the field is greater than a depth of the corresponding surface feature associated with the expected lane profile.

18. The method of claim 14, wherein analyzing the field characteristic of the aft portion of the field comprises comparing, with the computing device, a residue coverage parameter of the aft portion of the field to a baseline residue coverage parameter.

19. The method of claim 18, wherein the residue coverage parameter of the aft portion of the field is associated with a residue coverage value along a lane of the field worked by the ground engaging tool and the baseline residue coverage parameter comprises an expected residue coverage value for the lane associated with the ground engaging tool, wherein comparing the residue coverage parameter of the aft portion of the field to the baseline residue coverage parameter comprises comparing the residue coverage value detected along the lane to the expected residue coverage value of the lane associated with the ground engaging tool.

20. The method of claim 19, wherein the presence of material accumulation relative to the ground engaging tool is determined when the residue coverage value detected along the lane is less than the expected residue coverage value.
